(19) United States
(12) Patent Application Publication
(10) Pub. No.: US 2016/0040353 A1
(43) Pub. Date: Feb. 11, 2016

(54) METHOD FOR DEPOSITING A PHOTOCATALYTIC COATING AND RELATED COATINGS, TEXTILE MATERIALS AND USE IN PHOTOCATALYSIS

(71) Applicants: ECOLE NORMALE SUPERIEURE DE LYON, Lyon Cedex 07 (FR); UNIVERSITE CLAUDE BERNARD LYON I, Villeurbanne Cedex (FR); CENTER NATIONAL DE LA RECHERCHE SCIENTIFIQUE, Paris Cedex 16 (FR)

(72) Inventors: Damia GREGORI, Villeurbanne (FR); Chantal GUILLARD, Thil (FR); Frederic CHAPUT, Villeurbanne (FR); Stephane PAROLA, Jonage (FR)

(73) Assignees: Ecole Normale Superieure de Lyon, Lyon Cedex 07 (FR); Universite Claude Bernard Lyon I, Villerubanne Cedex (FR); Centre National de la Recherche Scientifique, Paris Cedex 16 (FR)

(21) Appl. No.: 14/775,143

(22) PCT Filed: Apr. 7, 2014
(86) PCT No.: PCT/FR2014/050822

§ 371 Date: Sep. 11, 2015

(30) Foreign Application Priority Data
Apr. 8, 2013 (FR) 1353122

(51) Int. Cl. D06M 15/643; B01J 35/02; B01J 31/06; D06M 23/08; B01J 21/06; D06M 11/79; D06M 11/45; D06M 11/46; B01J 35/00; B01J 21/08

(52) U.S. Cl. CPC D06M 15/643; B01J 35/0013; B01J 35/004; B01J 35/023; B01J 31/069; B01J 21/08; B01J 21/063; D06M 11/79; D06M 11/45; D06M 11/46; D06M 23/08

(57) ABSTRACT

A method for depositing a photocatalytic coating on a support, the method having the steps: a) providing an aqueous and/or alcoholic suspension of nanoparticles of a semiconducting material, b) providing a sol in an aqueous and/or alcoholic solution of a hydrolyzed organosilane, c) mixing the suspension and the sol and proceeding with deposition of the obtained mixture on the support to be covered, d) performing a drying operation, e) and optionally producing an illumination of the obtained coating after drying at one wavelength at least causing activation of the semiconducting material, so as to remove at least 3% of the organic groups initially present in the coating and bound to the silicon atoms through a Si—C bond; as well as coatings with photocatalytic properties, materials, notably textiles, covered with such a coating and the use of such coatings and materials for photocatalysis.

The present invention relates to the technical field of photocatalysis. More specifically, the invention relates to a method for preparing a coating having photocatalytic properties of degradation of chemical or biological agents, of coatings with photocatalytic properties, of textile supports and materials covered with such a coating and the use of such coatings, textile supports or materials for photocatalysis.

The field of photocatalysis notably finds application in decontamination in the broadest sense. Different solutions have been proposed, for example for imparting photocatalytic properties to supports of the textile type.

Patent application WO 2009/068833 in the name of PORCHER describes fibers including a coating integrating titanium dioxide particles. The coating in the examples consists of a fluorinated polymer, of a commercial silicon or of an acrylic polymer. A fluorinated polymer may be considered as a non-destructible matrix which confines the titanium dioxide particles which therefore cannot fully fill their role of photo-catalyst. In the case of the use of commercial silicon, the inventors of the present patent application have shown that it generated pollutants by desalting of organic groups present in the silicon matrix. Finally, as regards the last formulation comprising an acrylic binder proposed in patent application WO 2009/068833, the inventors of the present patent application have ascertained that a poly(methyl methacrylate) varnish containing TiO₂ nanoparticles (2% by mass) was totally degraded after one month of UV irradiation.

The same problem is encountered with the coatings described in patent application WO 2007/078555 which proposes textile supports for inner upholstery of cars on which a treatment based on a polyacrylic binder and on TiO₂ particles is applied.

Application WO 2010/001056 also describes a substrate in a silicon elastomer coated with at least one dirt-repellent film consisting of a silicon varnish integrating an active substance in photocatalysis. This dirt-repellent film is formed with alkenylsilanes and the inventors of the present patent application have demonstrated (see comparative Example 3) that such silicons with a vinyltrimethoxysilane matrix had low photocatalytic activity, notably because of the vinyl group which generates many intermediates during its degradation.

Application WO 2009/118479, as for it, describes textile fibers with photocatalytic properties on which semiconducting particles are directly applied, which causes rapid degradation of the textile fibers.

Mention may also be made of application WO 2010/010231 which describes acoustic tiles for depollution of air treated with a mixture of SiO₂ and of TiO₂. However, the obtained coatings are not flexible and therefore have to be adapted in order to cover flexible textiles or supports.

One of the goals of the present invention is to provide a coating, and an associated method, which has good photocatalytic properties and which, generally, allows improvement of the coatings as described previously and proposed in the prior art.

In particular, the coating according to the invention has to be suitable for treating flexible supports such as textiles.

Within the scope of the invention, this goal is achieved by using a porous coating formed with a silicon in which semiconducting material particles are homogenously distributed and are available so as to be used as pollutant traps without however causing degradation of the supporting material when the latter is organic. The invention gives the possibility of attaining such a goal by proposing a method for depositing a photocatalytic coating on a support comprising the following steps:
a) having available an aqueous and/or alcoholic suspension of nanoparticles of a semiconducting material,
b) having available a sol in an aqueous and/or alcoholic solution of a hydrolysed organosilane,
c) mixing the suspension and the sol and proceeding with the deposition of the obtained mixture on the support to be covered, and then
d) performing a drying operation.

Another goal of the invention is to propose coatings having stability and a sufficiently long lifetime. Also, according to an advantageous application of the method according to the invention, the latter comprises an additional step e) after the drying operation, consisting of achieving illumination of the coating obtained after drying, at one wavelength at least causing activation of the semiconducting material, so as to remove at least 3% of the organic groups initially present in the coating and bound to the silicon atoms through a Si—C bond. The removal rate of organic groups bound to the silicon atoms through a Si—C bond may notably be obtained, by making a comparison of the NMR spectra of silicon and by comparing the intensity of the peaks corresponding to the Si—C bonds. By organic groups initially present, are meant organic groups present before the illumination carried out in step e). The comparison will therefore be carried out by comparing the spectra before and after the illumination step e). Unlike the solutions of the prior art, according to this preferred embodiment, the coating proposed within the scope of the invention is stable and itself generates not very many organic pollutants during use.

Preferably, the illumination is carried out, until there is no longer any removal of organic groups bound to the silicon atoms through a Si—C bond. The illumination is for example carried out until the desalting of organic compounds by the coating is stopped. Such a stop may notably be ascertained, after concentration on an adsorbent and desorption of the pollutants, by chromatographic analysis. The obtained coating is then totally stable and in this way, it is avoided that the coating generates itself contaminants.

Within the scope of the invention, the illumination may be achieved by immersing the coating in an aqueous solution, notably water, and preferably ultrapure water. An example of ultrapure water which may be used within the scope of the invention is marketed by MilliQ and is characterized by a resistivity of 18.3 MΩ·cm. This immersion gives the possibility of efficiently displacing in the aqueous solution the organic compounds generated by the degradation of the organic groups bound to the silicon atoms through a Si—C bond. Thus, after removing the totality of the organic materials in contact with the photocatalyst, access to the latter is promoted for exterior pollutants.

The illumination is achieved by placing the coating in a medium maintained at a temperature belonging to the range from 0 to 80° C., notably to the range from 20 to 30° C. Such a medium will notably be an aqueous solution, for example water, and notably ultrapure water. But, producing the illumination by placing the coating in a gaseous atmosphere, of the air, oxygen, nitrogen, argon . . . type, may quite well be envisioned.

The illumination is preferably achieved under UVA, B and/or C, preferably at one wavelength at least or in a range of wavelengths belonging to the interval ranging from 200 to 400 nm, preferably with an intensity of 1 mW/cm² to 100 mW/cm², preferentially from 3 to 10 mW/cm², in particular for a duration from 10 minutes to 48 hours, and preferentially for a duration from 5 to 27 hours. The illumination conditions are adapted by one skilled in the art, in order to obtain the desired removal level of organic groups bound to the silicon atoms through a Si—C bond. When pollutants are present in a medium in which the coating is placed during illumination, the exposure time will be longer than in the absence of pollutants in the medium, in order to obtain optimum photocatalytic activity.

An illumination step according to step e) carried out in a short time, for example for a duration of less than 48 hours or even less than 12 hours, notably with the use of adapted radiation intensity and wavelength, gives the possibility of obtaining accelerated removal of organic groups bound to the silicon atoms through a Si—C bond. Gradual removal of organic groups bound to silicon atoms through a Si—C bond may be obtained in much longer times, by natural illumination of the coatings during use.

Within the scope of the invention, whether the illumination step b) is applied or not, the sol used in step b) may be obtained according to any known technique. Nevertheless, preferably, the sol is in an acid solution. In this case, hydrolysis of the organosilane, i.e. the introduction of Si—OH groups, is obtained with a pH of less than 7, preferably less than 3, for example obtained by adding hydrochloric acid. The sol may be in an aqueous solution or in an aqueous solution/alcohol mixture (designated as a hydro-alcoholic solution) or only in an alcohol. As examples of alcohol, mention may be made of methanol, ethanol, n-propanol, isopropanol and polyols.

The organosilane may be obtained from monosilylated and/or polysilylated precursors, for example selected from organotrialkoxysilanes, organotrichlorosilanes, organotris(methallyl)silanes, organotrihydrogensilanes, di-organosilanes such as di-organodialkoxy- or dichloro-silanes. The sol may be obtained by hydrolysis of an organosilane alone or of a mixture of an organosilane with another silylated entity, notably of the tetraalkoxysilane or tetrachlorosilane type.

The organosilane gives the possibility of introducing organic groups bound through a Si—C bone in the coating. Preferably, more than 10% by moles, preferentially more than 60% by moles, and still more preferably from 80 to 100% by moles of silicon atoms present in the sol, are bound to a carbon atom.

The method according to the invention, whether the illumination step b) has been applied or not, uses the well-known technique called a sol-gel process which allows the making of an organic-inorganic hybrid polymer through simple chemical reactions and at a temperature close to room temperature, generally at a temperature belonging to the range from 10 to 150° C., and preferentially to the range from 20 to 40° C., for preparing the sol. The variation of the experimental parameters such as temperature, concentration of precursor or composition of the solvent allows modulation of the final structure of the obtained coating.

The simple chemical reactions at the basis of the sol-gel process are triggered when the silylated entities or precursors are put in the presence of water: the hydrolysis of the Si-alkoxy, Si—Cl or Si—H functions, into Si—OH functions, first of all occurs and then an onset of condensation of the hydrolyzed products by formation of Si—O—Si bridges leads to the formation of a sol, and then when the condensation increases the gelling of the system.

Conventionally, a hydrolyzed organosilane sol in an aqueous, alcoholic or hydro-alcoholic solution consists of a colloidal suspension of nanoparticles of organohydroxysilane oligomers with a diameter of a few nanometers.

The condensation then continues in order to form a polymeric gel loaded with solvent, this is the sol-gel transition. The shaping of the coating and therefore the deposition on the surface are carried out during this step. Gelling occurs at the deposition time upon evaporation of the solvent and contacting of the silicate oligomers. Any deposition technique well known to one skilled in the art may be used: quenching, spraying, centrifugation, deposition by means of a doctor blade or a brush.

Once the deposition is completed, the solvent is then completely removed from the material with a drying step, optionally accompanied by a baking step. Such a heat treatment gives the possibility of completely finishing the drying and condensation of the species in the layer. Conventionally, the coating is subject to a drying operation, so as to obtain a condensation level from 90 to 100%. This drying may be carried out at a temperature belonging to the range from 20 to 500° C., and preferably, from 80 to 200° C., for example for a period from 30 seconds to one week, and preferably from 2 minutes to 20 hours.

Advantageously, the organic groups bound to the silicon atoms, bound through a Si—C bond in the organosilane making up the sol are selected from alkyl groups notably having from 1 to 6 carbon atoms, for example methyl, ethyl, n-propyl, iso-propyl, n-butyl, tert-butyl; aryl groups, for example phenyl; and the vinyl group. With such groups, the flexibility properties of the obtained coating are highly satisfactory and, consequently, the latter is particularly suitable for being used as a coating on flexible supports, of the textile type.

Generally, the organosilane sol used which will be mixed with the suspension of semiconducting nanoparticles, has a condensation level from 20 to 95%, preferably from 70 to 90%, and/or a dry extract from 1 to 80% by mass, and preferably from 5 to 50% by mass. The condensation level (Tc) of the sol may be determined by ²⁹Si liquid NMR. This technique gives the possibility of tracking the time-dependent change in the inorganic lattice Si—O—Si. The conventional notation for describing silicon spectra is the following: Tⁿ wherein T represents the silicon atom and n is the number of bridging oxygen atoms. The condensation level is thus defined as: Tc=[0.5 (area T¹)+1.0 (area T²)+1.5 (area T³)]/1.5.

Preferably, within the scope of the invention, in the suspension of semiconducting material nanoparticles, the latter are dispersed with a carboxylic acid such as acetic acid or a mineral acid such as phosphoric acid, with preferably a mass percentage of nanoparticles based on the total mass of the dispersion from 1 to 70%, and preferably from 5 to 30%. This allows optimization of the stability of the sols, of the photocatalytic properties of the coatings and of the activity/cost ratio of the final material.

Most often, the suspension and the sol will be formed with the same solvents: water, alcohol or a water/alcohol mixture.

Within the scope of the invention, the deposited mixture, obtained from the suspension of nanoparticles of a semiconducting material and from the sol, preferably comprises from 1 to 70% by mass, and preferably from 5 to 30% by mass of semiconducting material. Generally, the deposited mixture comprises a silicate species/semiconducting material mass ratio from 80/20 to 20/80 and preferably from 67/33 to 33/67, and preferentially from 60/40 to 40/60.

Advantageously, the deposited mixture, and therefore also the obtained coating, does not include any surfactant acting as a porogenic agent. Also advantageously, the deposited mixture does not include any nitrogen-containing compounds and the coating does not include any nitrogen.

Within the scope of the invention, by <<semiconducting material>>, is meant any material for which the electron structure corresponds to a valency band and to a conduction band characterized by an energy difference called the forbidden band or <<gap>>. When a semiconducting material receives a photon with energy greater than or equal to that of the forbidden band of this material, an electron-hole pair is created in the material. The nanoparticles of semiconducting material present in the coatings according to the invention may be used for generating oxidation-reduction reactions with organic compounds coming into contact with the semiconducting material, with view to photocatalytic degradation of these compounds.

The semiconducting material used within the scope of the invention has photocatalytic properties for degradation of organic compounds, in particular of chemical or biological agents.

Within the scope of the invention, the semiconducting material nanoparticles advantageously have a larger size belonging to the range from 5 to 100 nm. The semiconducting material nanoparticles for example are nanoparticles of TiO₂, ZnO, SnO₂, WO₃, Fe₂O₃, Bi₂O₃, SrTiO₃, CdS, SiC or CeO₂ or a mixture of such nanoparticles. The nanoparticles consisting of more than 50% by mass, or exclusively of TiO₂ anatase, are preferred. For example, it is possible to use particles consisting of a rutile/anatase mixture. Titanium dioxide (TiO₂) is a semiconductor with a wide band provided with great chemical and photochemical stability. The absorption band of TiO₂ corresponds to a wavelength 400 nm (UV range). By using doped TiO₂ nanoparticles (for example with carbon or nitrogen), it will be possible to displace this band into the visible light spectrum, while increasing the energy yield of photocatalysis. Such semiconducting material nanoparticles are also known for their protective properties against UVs. Thus, the coatings according to the invention, either obtained or not after the illumination step e), may be used for protection against UVs.

The object of the present invention is also coatings consisting of a polysiloxane, for which some of the silicon atoms are bound through a Si—C bond to at least one organic group, and wherein nanoparticles of a semiconducting material are distributed, characterized by the fact that they are porous, and notably have macroporosity, or also even mesoporosity and/or by the fact their illumination when the latter are immersed in an aqueous solution, in particular of ultrapure water, does not cause any removal of organic groups present in the coating and bound through a Si—C bond to the silicon atoms. In particular, such an illumination may be achieved with UV-A, UV-B or UV-C from 1 mW/cm² to 100 W/cm², preferentially from 3 to 10 mW/cm², for 10 minutes to 48 hours, preferentially for a period of 5 to 27 hours, at a temperature comprised between 0 and 80° C., preferably between 20 and 30° C. An irradiation consisting of UVA (λ=365 nm) and UVB (λ=312 nm) having a respective light intensity of 10 mW/cm² and of 3 mW/cm², will for example be applied for 6 hours or more, at room temperature (for example at 22° C.), for checking for the absence of desalting of an organic group.

The coatings according to the invention include a porous silicon matrix confining nanoparticles of a semiconducting material. The macroporosity present at the surface and in the bulk of the coating makes available the nanoparticles of semiconducting material for trapping organic pollutants.

Preferably, from 17 to 97% by moles, and preferably from 80 to 95% by moles, of silicon atoms present in the coatings according to the invention are bound to a carbon atom through a Si—C bond.

The organic groups bound through a Si—C bond to the polysiloxane matrix give its flexibility to the coating. The organic groups bound to the silicon atoms through a Si—C bond are preferably selected from alkyl groups notably having from 1 to 6 carbon atoms, for example methyl, ethyl, n-propyl, iso-propyl, n-butyl, tert-butyl; aryl groups, for example phenyl; and the vinyl group. In the case of a coating for which the illumination (when the latter is immersed in an aqueous solution, in particular of ultrapure water), still causes removal of organic groups present in the coating, the organic groups bound to the silicon atoms through a Si—C bond are preferably of the methyl or ethyl type.

The coatings according to the invention notably comprise from 1 to 90% by mass, and preferably from 30 to 70% by mass of a semiconducting material. In the coatings according to the invention, the semiconducting material nanoparticles generally have a larger size belonging to the range from 5 to 100 nm.

In the coatings according to the invention, the semiconducting material nanoparticles are for example nanoparticles of TiO₂, ZnO, SnO₂, WO₃, Fe₂O₃, Bi₂O₃, SrTiO₃, CdS, SiC or CeO₂ or a mixture of such nanoparticles, the nanoparticles consisting of more than 50% by mass, or exclusively of TiO₂ anatase being preferred. Advantageously, the semiconducting material nanoparticles are nanoparticles of TiO₂, ZnO, SnO₂, WO₃, Fe₂O₃, Bi₂O₃, SrTiO₃, CdS, or a mixture of such nanoparticles, and the Si atoms/metal atoms ratio of the semiconducting material nanoparticles belongs to the range from 0.3/1 to 5/1, preferably 1.2/1.

Advantageously, the coatings according to the invention are flexible. Their flexibility may be evaluated by their capability of being able to be folded with an angle of 30° without breaking, when they are deposited on a support, itself a flexible support. In particular, the presence of the coating on a flexible support does not significantly modify (causing a variation of less than 5%) the force required for folding the support according to an angle of 30°.

Because of their porous nature, the coatings according to the invention have surface roughness.

According to preferred embodiments, the coatings according to the invention consist of at least 90% by mass, and preferably exclusively consist of a matrix of polysiloxane for which one portion of the silicon atoms are bound through a Si—C bond to organic groups and of nanoparticles of a semiconducting material.

The object of the invention is also the coatings which may be obtained according to the method defined within the scope of the invention, regardless of its alternative application.

With the sol-gel process used, it is possible to obtain coatings of relatively small thickness, notably of the order of 1 nm to 500 μm, and preferably from 50 nm to 50 μm.

Because of the application of steps a) to d) of the method described within the scope of the invention, a coating having a porosity, with the presence of a macroporosity, and most often both macroporosity and mesoporosity in the case of TiO₂ particles, is obtained. The presence of such a porosity will be used as a trap for pollutants and increase the availability of the semiconducting material nanoparticles of the coating.

Within the scope of the invention, the presence of a macroporosity, or also even of a mesoporosity, may be determined by observing images of the surface of the coating with scanning electron microscopy. A macroporosity may be defined as corresponding to the presence of pores with a diameter of more than 50 nm and mesoporosity to the presence of pores with a diameter comprised between 2 nm and 50 nm. The diameter of a pore corresponds to the largest distance measured between the internal surfaces of a cavity corresponding to a pore present in the coating, by observing images of the surface of the coating with scanning electron microscopy. The surface porosity and the porosity in the bulk of the coating are substantially identical. Gas adsorption analyses, notably of nitrogen, by the BET (Brunauer, Emmett and Teller) technique also give the possibility of confirming the presence of a porosity of the macroporosity type or of the macro/meso mixed porosity type. Such measurements are carried out on the powder obtained by scraping the deposited coating.

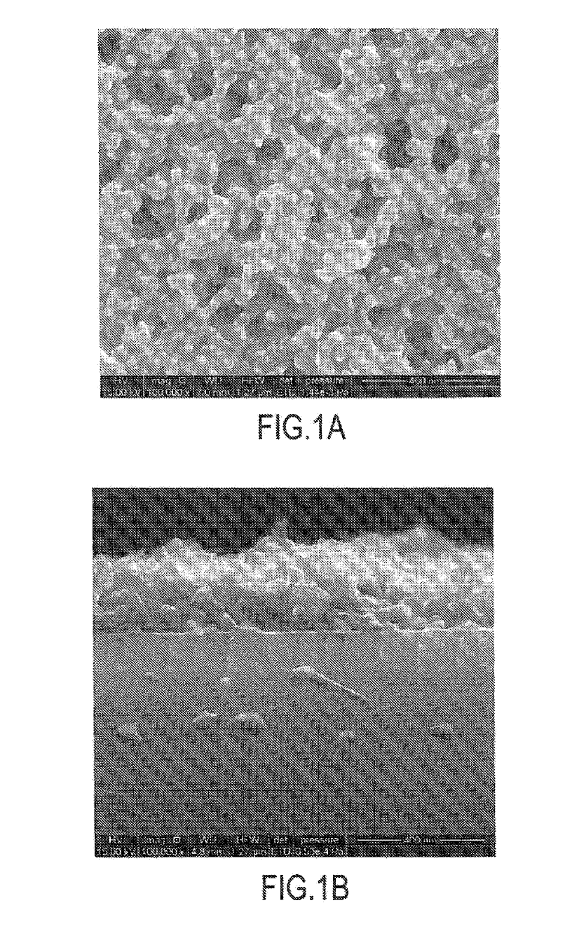

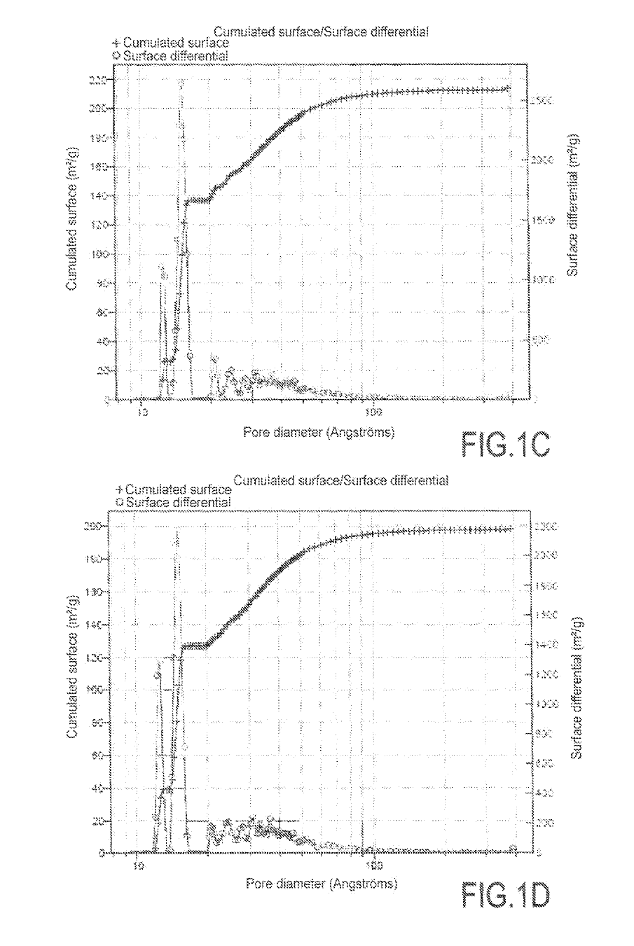

The presence of a macro/meso mixed porosity is visible in FIG. 1A which is a photograph obtained by scanning electron microscopy, of the coating according to Example 1 hereafter. Because of the presence of porosity, the coating obtained according to Example 1 hereafter has a surface roughness, as this is apparent from FIG. 1B.

The treatment step e) under illumination gives the possibility of obtaining coatings with optimum photocatalytic properties: it allows removal of the organic groups bound to the silicon atoms which are located in proximity to the semiconducting material nanoparticles and will thus allow generation of a more stable material, which itself will generate (or in a very limited way depending on the removal level) contaminants during its use. The obtained coating has a mixed porosity corresponding to porosity of the macroporosity type or of the macro/mesoporosity mixed type on the one hand, and to microporosity generated by the removal of the organic groups located in proximity to the semiconducting material nanoparticles on the other hand. The presence of a microporosity cannot be measured, no technique being available for such a measurement on a thin layer in the absence of structuration, like in the present case. It was indirectly inferred by combining the analyses of the composition of the coating demonstrating the removal of the Si—C bonds because of the removal of the R groups initially present and formation of Si—O bonds. This automatically causes cracks generating microporosity upon corresponding evolvement of degradation gases.

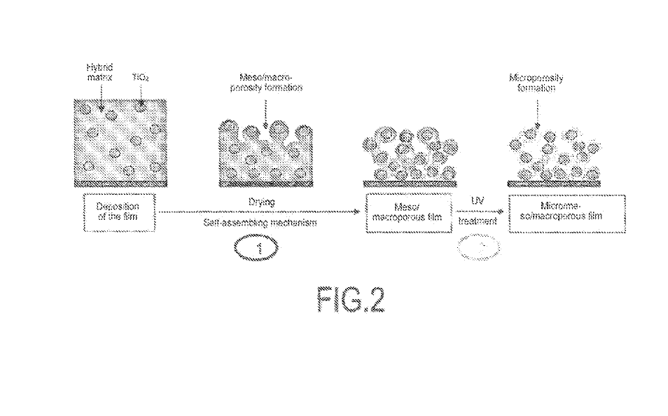

This removal is obtained by the activation of the properties of the semiconducting nanoparticles during illumination. The generated microporosity will also increase the accessibility of the photocatalytic nanoparticles present in the coating and thus increase the photocatalytic activity of the coating according to the invention, as compared with coatings obtained without this treatment step. A multi-step mechanism for forming such a hierarchical porosity is shown in FIG. 2: First of all macroporosity or mixed macro/meso porosity is formed by self-assembling of the semiconducting material nanoparticles (TiO₂ in the Example illustrated in FIG. 2) during the steps for depositing and drying the coating (as a film); and then microporosity is generated by degradation of the organic groups bound through a Si—C bond to the silicon atoms of the polysiloxane network in contact with the semiconducting material nanoparticles (TiO₂ on the Example illustrated in FIG. 2) by applying a UV pre-treatment.

The step for treatment under irradiation therefore has a double function: Remove the organic groups which may be degraded by the semiconducting material nanoparticles and generate microporosity which will increase the available active exchange surface area, upon subsequent use of the coating. Both contribute to considerably improving the photocatalytic activity obtained.

The coatings according to the invention may be used in photocatalysis. The photocatalytic degradation from coatings according to the invention may be achieved between about −10 and 150° C. and for example at room temperature (20-30° C.). This degradation may be obtained from the coating under natural or artificial illumination, for example under exposure to visible light and/or ultraviolet radiation. By ultraviolet radiation is meant an illumination with a wavelength of less than 400 nm, and for example comprised between 350 and 390 nm in the particular case of UV-A radiation. By visible light, is meant an illumination with a wavelength comprised between 400 and 800 nm, and in the case of solar light, is meant an illumination comprising a small proportion of UV-A and a wide proportion of visible light, with a spectral distribution simulating that of the sun or being that of the sun. The illumination will be achieved at one wavelength at least selected for activating the semiconducting material.

The coatings according to the invention may be used for removing the volatile organic compounds (VOC), the gases, the odors, the fungi, the living organisms such as fungi, bacteria and viruses. In particular, the coatings according to the invention may be applied on supports of inorganic or organic nature, for example of the textile, paper, plastic material, polymer, ceramic, glass, metal surface type . . . . The coated supports may be flexible, like textiles, certain plastic supports or notably papers, or rigid supports like glass, certain plastic or polymeric supports, metal surfaces. In the case of rigid supports, the method according to the invention gives the possibility of providing porous coatings providing satisfactory photocatalysis properties. In the case when the irradiation step is applied in an accelerated way, by applying sufficient illumination or by illumination being achieved during the use of the coating or support, it gives the possibility of generating an additional microporosity further improving the photocatalysis properties, notably as compared with a coating which would be achieved in a matrix exclusively consisting of polysiloxane, without any organic group.

Generally, the coatings and coated supports according to the invention may be used for photocatalytic degradation of any type of organic compounds based on C, H, O, etc. These may be dirt or stains, or any type of compounds depending on the contemplated applications. The coatings may be applied on fibers or textiles, notably in order to form technical fabrics, fabrics for furniture, medical fabrics, trims for automobiles or public transport. The coatings according to the invention may be used in different applications, such as the cleaning of surfaces, treatment of water, cleaning of air, for forming a self-cleaning coating, notably in the field of lighting, automobiles or domestic appliances.

The object of the present invention is also a textile material or more generally a support covered with a coating according to the invention. The coating will be positioned on the textile material, by carrying out the deposition step of step c) of the method according to the invention directly on the material to be covered. Within the scope of the invention, the presence of the polysiloxane matrix ensures protection of the textile and more generally of the support bearing the coating, by avoiding degradation of the latter, even if it is of an organic nature, by the action of the semiconducting material. The bond existing between the support and the coating is ensured via Si—O bonds.

The invention also relates to the use of a coating, of a support, or of a textile material as defined within the scope of the invention, for photocatalytic degradation of organic compounds, in particular of biological or chemical agents.

The examples below, with reference to the appended figures, give the possibility of illustrating the invention and do not have any limitation.

FIGS. 1A and 1B are scanning electron microscope images (SEM) of the surface and of a section of the coating obtained in Example 1.

FIGS. 1C and 1D show the analyses curves obtained by the BET (Brunauer, Emmett and Teller) technique of the coating obtained in Example 1, before and after UV treatment, respectively.

FIG. 2 proposes a multi-step mechanism for forming the hierarchical porosity of the obtained coating, during application of a method according to the invention including the steps a) to e).

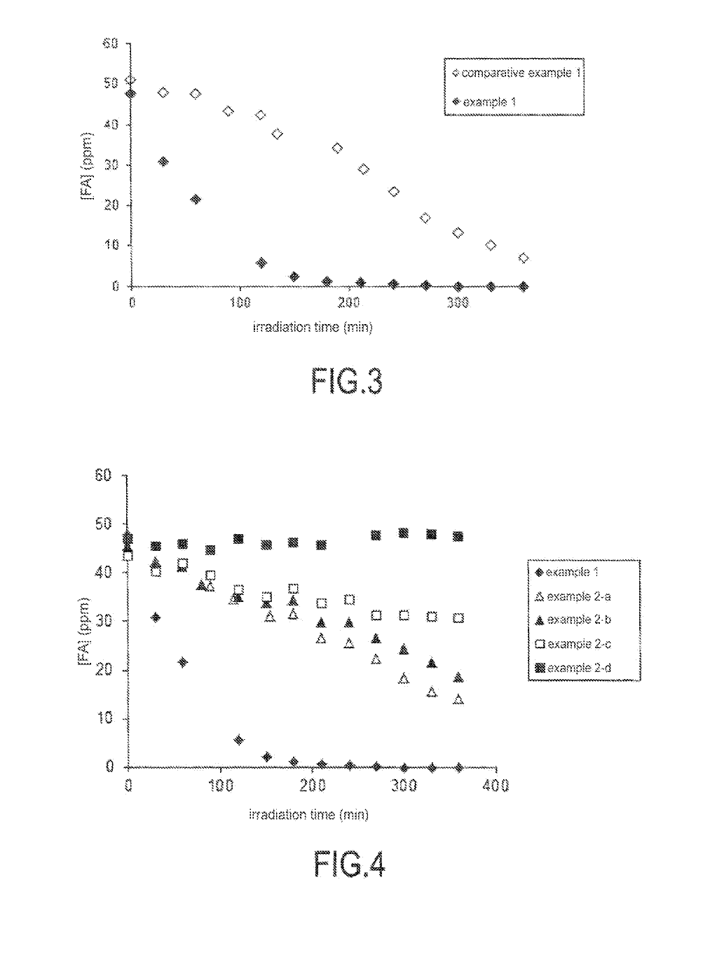

FIG. 3 shows the degradation kinetics of formic acid, obtained with the coating of Example 1, versus the UV exposure time.

FIG. 4 illustrates the degradation kinetics of formic acid, obtained in Example 2, depending on the UV exposure time and according to the mass % of SiO₂ coming from the sol without any organic material.

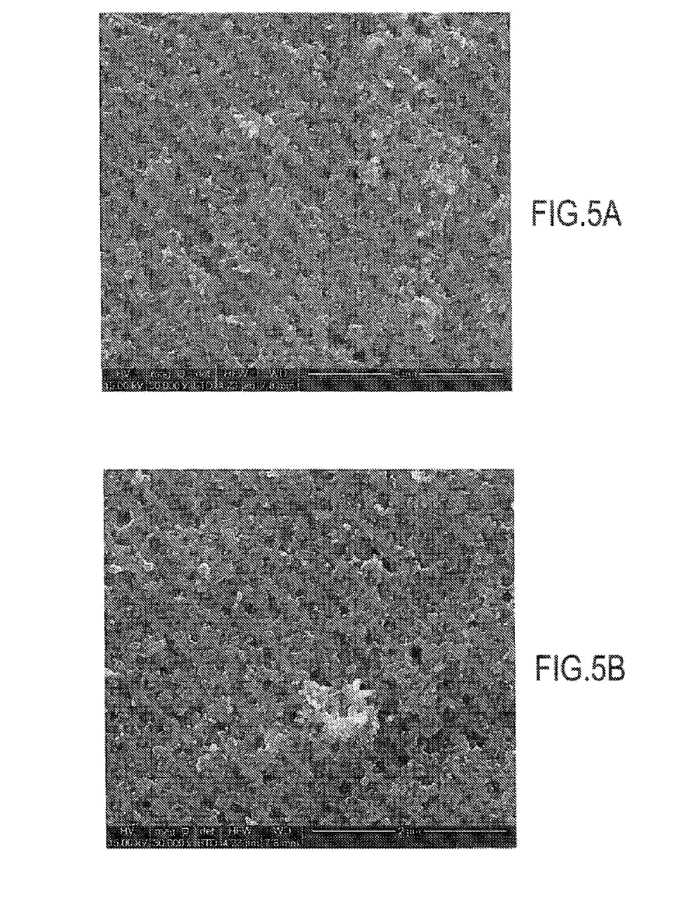

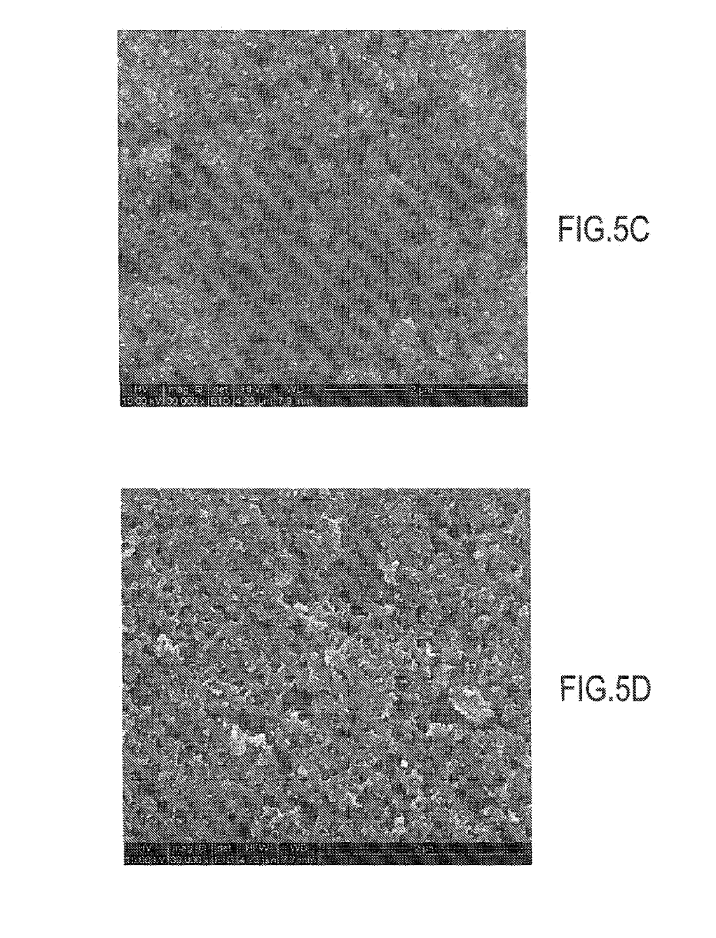

FIGS. 5A, 5B, 5C and 5D are scanning electron microscope images (SEM) of the surface of the coatings obtained in Examples 3-a, 3-b, 3-c and 3-d, respectively.

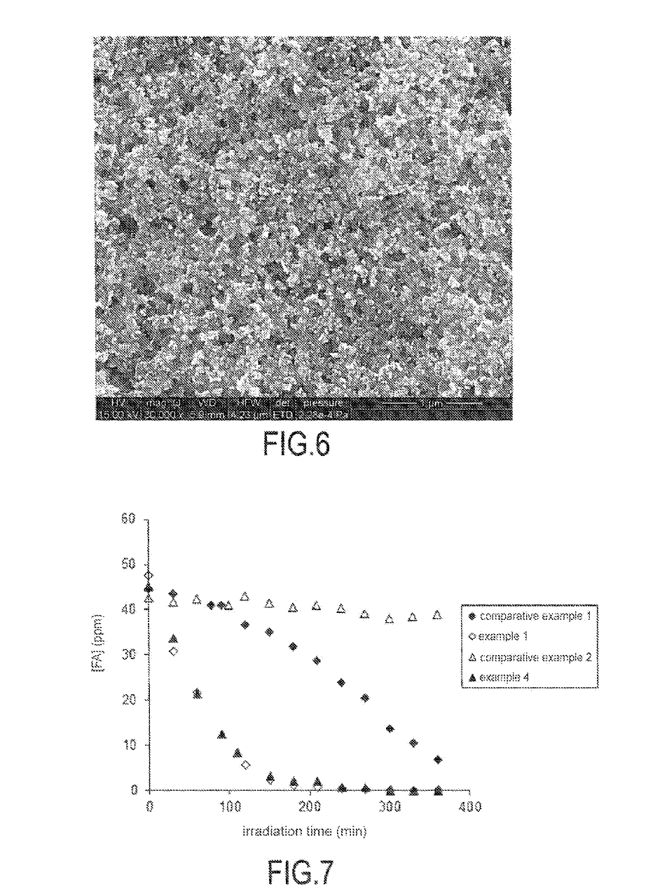

FIG. 6 is a scanning electron microscope image (SEM) of the surface of the coating obtained in Example 4.

FIG. 7 shows the time-dependent change in the degradation of formic acid versus the UV irradiation time, obtained in Example 4, according to the condensation level of the hybrid sol used.

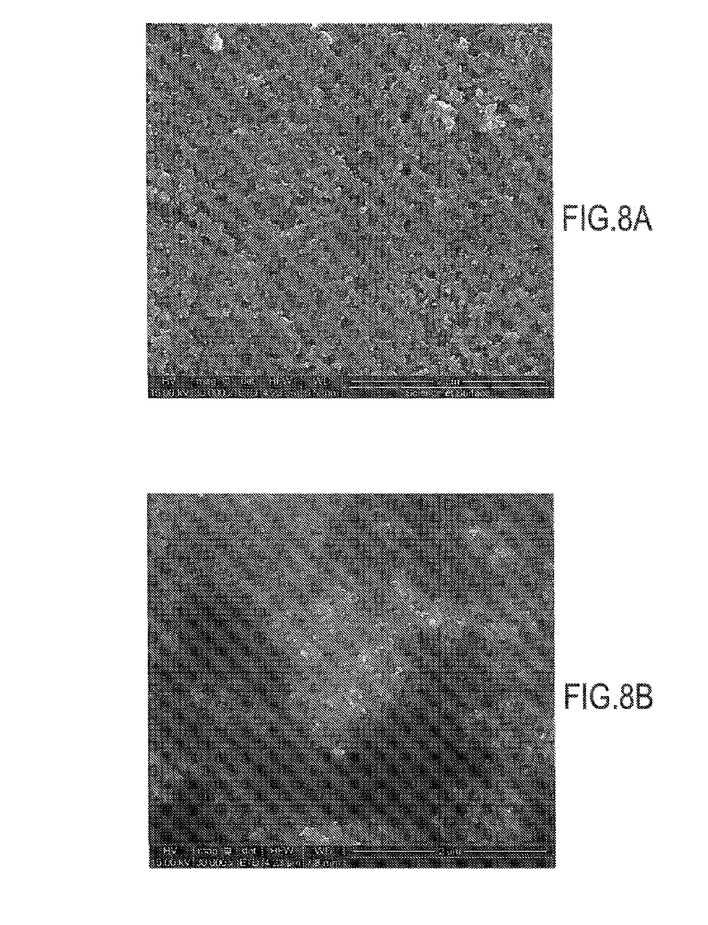

FIGS. 8A and 8B are scanning electron microscope images (SEM) of the surface of the coatings obtained in Examples 5-a and 5-b, respectively.

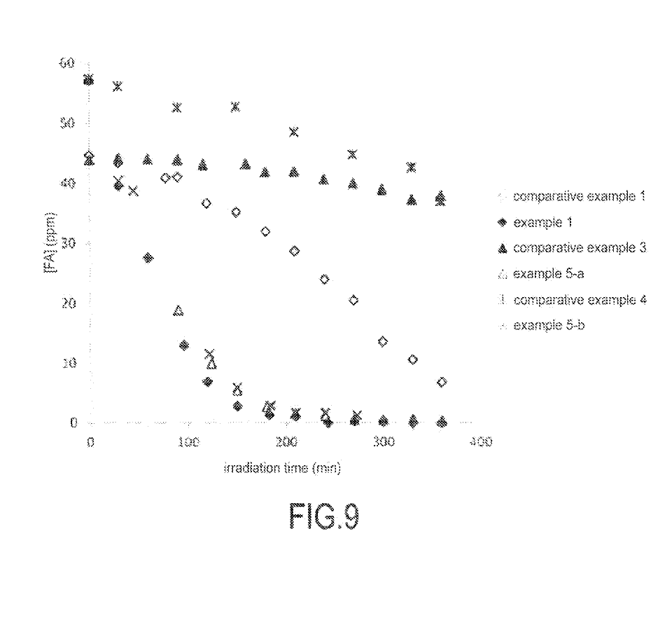

FIG. 9 shows the time-dependent change in the degradation of formic acid versus the UV irradiation time, obtained in Example 5, according to the nature of the organic group of the hybrid sol used.

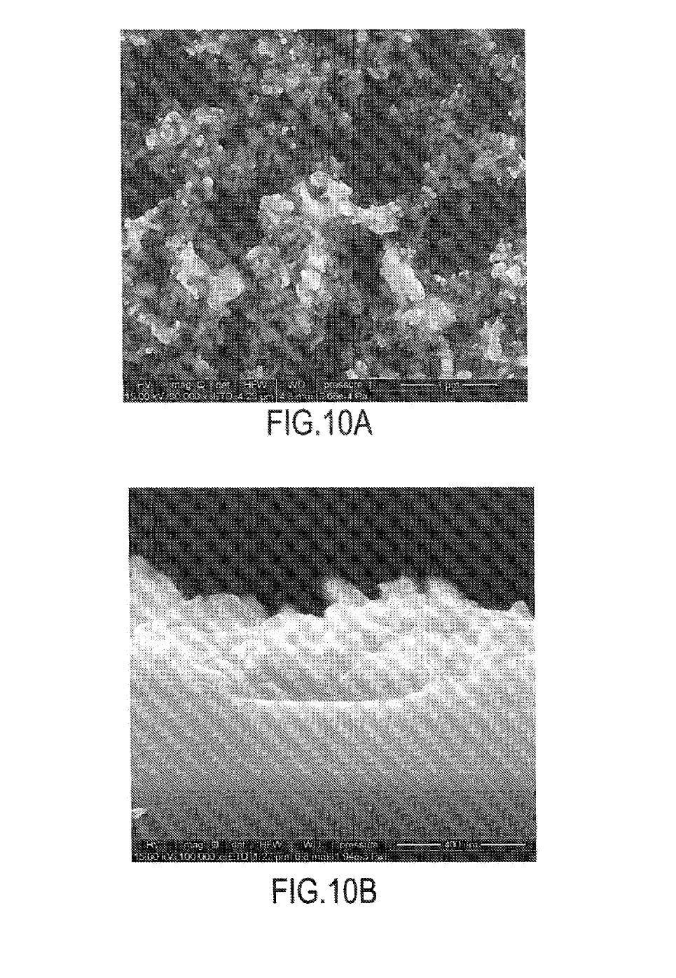

FIGS. 10A and 10B are scanning electron microscope images (SEM) of the surface and of a section of the material obtained in Example 6.

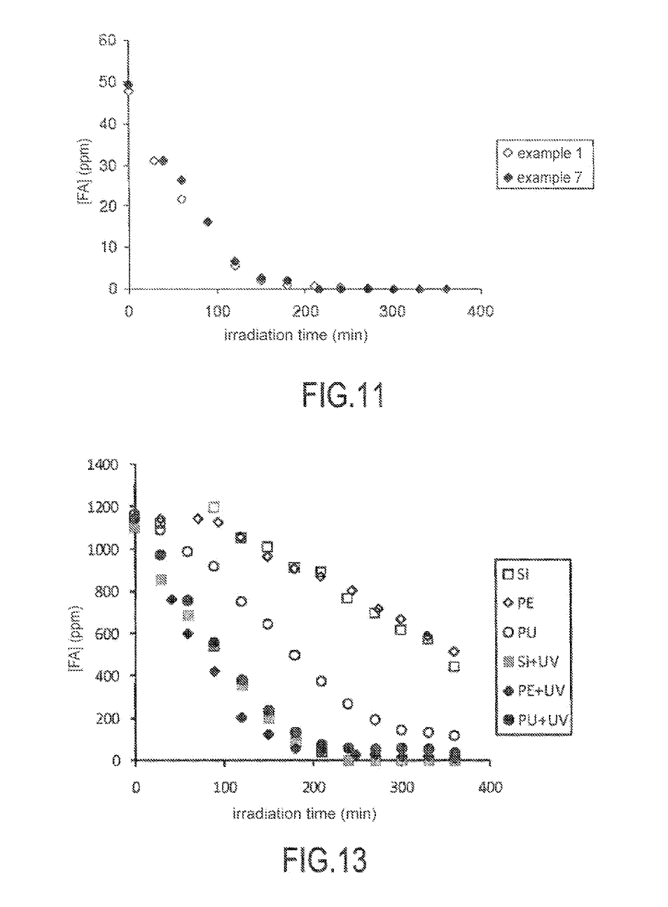

FIG. 11 illustrates the degradation kinetics of formic acid versus the UV exposure time, obtained in Example 7.

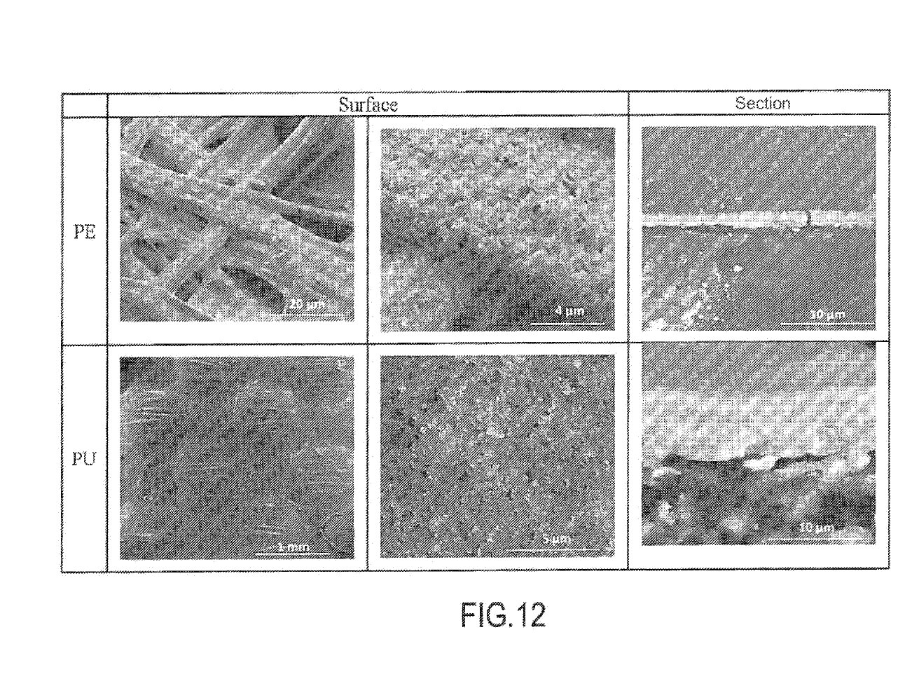

FIG. 12 shows scanning electron microscope images (SEM) of the surface and of the section of the materials obtained in Example 8.

FIG. 13 illustrates the degradation kinetics of formic acid versus the UV exposure time with the materials of Example 8, as compared with those of Example 1.

### ²⁹SI LIQUID NMR

The ²⁹Si NMR analyses are carried out by means of a Bruker DRX400 spectrometer at room temperature. The liquid NMR measurements of silicon 29 (79.49 MHz) are recorded by using a pulse duration of 8 μs. The recycling time is 5 s. The samples are placed in a tube with a diameter of 5 mm containing a 1 mm capillary filled with deuterated acetone (D6) and with reference Tetramethylsilane (TMS). 128 scans were accumulated for each sample. The program MestReNova is used for estimating the percentage distribution of the various species present in the hybrid sol-gel materials.

### ²⁹SI SOLID NMR

The spectra were recorded on a 500 MHz WB Avance III Bruker spectrometer equipped with a 4 mm DVT probe. The resonance frequencies are 500.16 MHz for ¹H and 99.36 MHz for ²⁹Si. The magic angle spinning rate is 10 kHz. The analysis is carried out by direct excitation with proton decoupling (spinal decoupling 80 kHz) with a relaxation time of 300 s and a number of scans of 200.

### ICP

The samples are put into solution with acid attack in a bomb (H₂SO₄+HNO₃+HF) and heating in an oven at 150° C. for 12 hours. The dosage of the Ti and Si elements is ensured by ICP-OES (Inductively Coupled Plasma-Optical Emission Spectrometry). The analyses are carried out on an <<Activa>> apparatus of the Jobin Yvon brand. The latter gives the possibility of covering a spectral range from 160 nm to 800 nm.

### SEM

The SEM micrographs are taken on a FEI Quanta 250FEG apparatus equipped with an SDD Bruker detector. The operating parameters were the following:
Acceleration voltage: 15 kV
Operating distance: 4-7 mm
Magnification: ×30,000 to ×100,000

### HPLC

The high pressure liquid phase chromatography system comprises a VarianProstar Model 410 pump and a detector with a photodiode array UVVarianProstar 330 PDA adjusted to 210 nm. The method used for separating the molecules is ionic chromatography with an H⁺ cation exchanger column (Sarasep CAR-H 7.8 mm×300 mm) effective for separating organic acids and alcohols. The eluent used as a mobile phase is H₂SO₄ at 5·10⁻³ M with a flow rate of 0.7 ml min⁻¹. The injected volume of the sample is 20 μl.

### IRRADIATION BOX

Bio-link, Fisher Scientific, L×P×H=260×330×145 mm.

### BET

The porosity is studied by nitrogen adsorption/desorption at liquid nitrogen temperature (77 K). The nitrogen adsorption/desorption isotherms are obtained with a Micromeritics ASAP 2010 apparatus. Before analyses, the samples are degassed in vacuo at a temperature of 350° C. for 7 hours.

### EXAMPLE 1

### Influence of a UVC Pre-Treatment of the Films

A slurry of titanium dioxide (TiO₂) is prepared by mixing 0.83 g of commercial nanoparticles (P-25 Degussa, anatase/rutile crystalline form in a ratio comprised between 70/30 and 80/20, a size between 25 and 35 nm) with 0.62 ml of acetic acid. The slurry formed is then dispersed in 6.7 ml of ethanol by sonication for 1 minute.

To the obtained suspension, 2.4 g of a hybrid silica sol synthesized by acid hydrolysis of CH₃—Si(O—CH₂—CH₃)₃ precursors according to the following procedure, are added:

In a flask, 14 moles of acidified water with a pH=3.5 (HCl) are added to 1 mole of CH₃—Si(O—CH₂—CH₃)₃ precursor. The solution is left for stirring for 17 hours. The generated alcohol is then removed by azeotropic distillation at 135° C. The last drops are removed by distillation in vacuo with a rotary evaporator. The water is separated from the sol by adding ether to the solution. The aqueous phase located below is removed. Several rinses with water are carried out in order to remove the remaining HCl trace amounts. MgSO₄ is introduced for removing the last water molecules. Ethanol, the final solvent, is added and the ether is removed with the rotary evaporator. Ethanol is added again according to the desired dry extract.

The sol used has a dry extract representing 34% by mass of the total mass of the sol and a condensation level of 88%. The solution is again sonicated for 1 minute before being applied on the substrates.

The obtained solution finally consists of 10% by mass of silica and is loaded with 10% by mass of titanium dioxide nanoparticles. This solution has a SiO₂/TiO₂ mass ratio of 50/50.

The solution is deposited on silicon substrates (with a surface of 9 cm²) by dip-coating at a rate of 50 mm/min. The obtained film is dried in the oven at 120° C. for 20 hours. A photocatalytic film about 300 nm thick and having a macroporosity and a mesoporosity with pores randomly distributed in shape and in size (with pore diameters between 20 and 400 nm) is thereby obtained. This porosity will be used as a trap for pollutants and will increase the availability of TiO₂ nanoparticles of the film.

FIGS. 1A and 1B are scanning electron microscope images (SEM) of the surface and of a section of the obtained coating.

FIGS. 1C and 1D have analyses curves obtained by the BET (Brunauer, Emmett and Teller) technique of the coating obtained before and after UV treatment respectively and also give the possibility of confirming the presence of such a mixed porosity, before and after UV treatment. These curves confirm the presence of macroporosity and of mesoporosity. On the other hand, the present values below 2 nm are not significant and not representative of the presence of microporosity, since they are located below the reliable and quantifiable detection threshold of the apparatus.

The thereby prepared coating is treated by UVC irradiation (irradiation box, λ=254 nm) at a light intensity of 6 mW/cm² for 27 hours. During the irradiation, the substrate is totally immersed in water. With this treatment it is possible to destroy the methyl groups of the silica matrix located in proximity to the TiO₂ nanoparticles. It should be noted that the same results are observed with a treatment with UVA irradiation.

²⁹Si solid NMR analysis conducted on the samples before and after UV treatment confirms the degradation of the methyl groups in a proportion of about 5%. The reduction of the peaks corresponding to T² and T³ is observed in favour of the formation of new peaks Q³ and Q⁴. After the treatment step, 95% of the silicon atoms are bound to a carbon atom.

The photocatalytic activity of the obtained material is evaluated, in an aqueous medium by following the degradation of a pollutant (formic acid) according to the UV exposure time.

The photocatalytic degradation tests were conducted by using a UV lamp (Philips HPK 125W lamp) and a cooling system which gives the possibility of avoiding overheating of the lame. A water tank equipped with optical filters is positioned in front of the lamp in order to prevent any heating up and allowing selection of the wavelengths emitted by the lamp. During the tests, Pyrex optical filters are used for cutting off the wavelengths of less than 290 nm. The sample to be tested is placed inside a reactor at 1 cm from its bottom. The reactor being itself positioned above the UV lamp and the water tank. The lamp−reactor distance is 2.5 cm. Under these conditions, the UV irradiation consists of UVA (λ=365 nm) of intensity 10 mW/cm² and of UVB (λ=312 nm) of intensity 3 mW/cm².

An aqueous solution of 30 ml of formic acid (FA) at a concentration of 50 ppm is introduced into the photoreactor. A stirring system is used for homogenizing the aqueous phase. The formic acid solution is stirred in darkness for half an hour before irradiation in order to attain the adsorption equilibrium. The photocatalytic test is carried out room temperature (20° C.). Samples are taken every 30 minutes for six hours. The degradation of formic acid during the irradiation time is tracked by high performance liquid chromatography (HPLC). It is thus possible to determine a degradation rate of formic acid (FA) in ppm/min.

The evaluation of the photocatalytic activity of the material is carried out before (COMPARATIVE EXAMPLE 1) and after treatment under UVC (EXAMPLE 1). FIG. 3 shows the degradation kinetics of formic acid versus the UV exposure time. Table 1 summarizes the obtained degradation rates.

TABLE 1

EXAMPLE No.

| | COMPARATIVE 1 | 1 |
|---|---|---|
| Degradation rate | 0.16 | 0.44 |
| (ppm/min) | | |

FIG. 3 clearly shows the importance of the UVC pre-treatment of the films which allows total removal of the pollutant within 3 hours. A non-pretreated sample degrades 87% of FA in 6 hours. With the pre-treatment, the degradation rate is nearly tripled by passing from 0.16 ppm/min to 0.44 ppm/min of destroyed FA. These results suggest the formation of microporosity with the destruction of organic groups of the film and improvement in the accessibility of the pollutants to titanium dioxide.

### EXAMPLE 2

### Influence of the Concentration of Organic Groups in the Silica Matrix

The concentration of organic groups of the film (from the hybrid silica sol) is modulated by adding various amounts of a silica sol without any organic material. This sol is synthesized by acid hydrolysis of precursors Si(O—CH₂—CH₃)₄. Its dry extract is 18% and its condensation level is 80%.

Otherwise, the synthesis procedure is identical with that of EXAMPLE 1, the addition of the sol without any organic is ensured in the same time as the addition of the hybrid sol. The proportions of sols without any organic are summarized in Table 2:

TABLE 2

| | Mass % of SiO₂ |
|---|---|
| | stemming from |
| | the sol without |
| EXAMPLE No. | organics* |
| 1 | 0% |
| 2-a | 18% |
| 2-b | 54% |
| 2-c | 77% |
| 2-d | 100% |

*Relatively to the total SiO₂ mass present in the final solution

The evaluation of the photocatalytic activity of the films remains similar to that described in EXAMPLE 1 but increases with the % of organosilane. FIG. 4 represents the degradation kinetics of formic acid versus the UV exposure time and according to the mass % of SiO₂ from the sol without any organic. Table 3 summarizes the obtained degradation rates.

TABLE 3

| | EXAMPLE No. | | | | |
|---|---|---|---|---|---|
| | 1 | 2-a | 2-b | 2-c | 2-d |
| Degradation | 0.44 | 0.09 | 0.07 | 0.04 | 0 |
| rate | | | | | |
| (ppm/min) | | | | | |

The obtained results demonstrate the importance of using a hybrid silica sol as a matrix: the more reduced is the proportion of introduced hybrid sol, the more the photocatalytic activity decreases. It is for example confirmed that once the methyl groups are destroyed by UVC, sufficient space is released in order to promote access of the pollutants to the TiO₂ nanoparticles.

### EXAMPLE 3

### Variation of the SiO₂/TiO₂ Mass Ratio

In order to vary the SiO₂/TiO₂ mass ratio, one acts on the mass % of TiO₂ and SiO₂ nanoparticles in the final solution.

A synthesis procedure identical with that of EXAMPLE 1 is used, but the introduced proportions of the different constituents (TiO₂ and SiO₂ nanoparticles) are modulated according to Table 4:

TABLE 4

| | | Mass % of TiO₂ | |
|---|---|---|---|
| EXAMPLE | Mass % of SiO₂ in | in the final | SiO₂/TiO₂ mass |
| No. | the final solution | solution | ratio |
| 1 | 10% | 10% | 50/50 |
| 3-a | 5% | 10% | 33/67 |
| 3-b | 15% | 10% | 60/40 |
| 3-c | 10% | 5% | 67/33 |
| 3-d | 10% | 15% | 40/60 |

FIGS. 5A, 5B, 5C and 5D are scanning electron microscope images (SEM) of the surface of the coatings obtained in Examples 3-a, 3-b, 3-c and 3-d. These images show macroporosity and mesoporosity with pores of random shape and size (with pore diameters between 20 and 600 nm).

The evaluation of the photocatalytic activity of the materials is carried out according to the method described in EXAMPLE 1. The films containing more SiO₂ have to be pre-treated for a longer time in order to obtain the same photocatalytic activity (about 40 hours for SiO₂/TiO₂ having a mass ratio of 60/40).

All the tested films, which have SiO₂/TiO₂ mass ratios comprised between 67/33 and 33/67, therefore have a photocatalytic activity. The efficiency optimum is obtained with a SiO₂/TiO₂ mass ratio of 50/50. The minimum is obtained with a ratio 67/33. Further, it may be noted that the increase in the amount of TiO₂, by passing from a SiO₂/TiO₂ mass ratio from 50/50 to 33/67, does not improve the activity of the material.

### EXAMPLE 4

### Influence of the Condensation Level of the Hybrid Silica Sol

A hybrid silica sol is used having a condensation level of 62%, instead of that at 88% synthesized by acid hydrolysis of CH₃—Si(O—CH₂—CH₃)₃ precursors. For this, 1 mole of CH₃—Si(O—CH₂—CH₃)₃ precursor, 3 moles of acidified water at pH=2.5 (HCl) and 3 moles of ethanol are added with strong stirring. The solution is left with stirring for 17 hours before being stored in the freezer. The obtained sol has a dry extract of 20%. The remainder of the procedure for preparing the film remains the same as the one of EXAMPLE 1. FIG. 6 is a scanning electron microscope image (SEM) of the surface of the coating obtained in Example 4. This image shows macroporosity and mesoporosity with pores of random shape and size (with pore diameters between 20 and 400 nm).

The evaluation of the photocatalytic activity of the material is carried out according to the method described in EXAMPLE 1. FIG. 7 shows the time-dependent change in the degradation of formic acid versus the UV irradiation time according to the condensation level of the hybrid sol used. The photocatalytic activity was studied in each of the cases before (COMPARATIVE EXAMPLES 1 and 2) and after the UVC pretreatment (EXAMPLE 1 and EXAMPLE 4). Table 5 summarizes the obtained degradation rates.

TABLE 5

| | EXAMPLE No. | | | |
|---|---|---|---|---|
| | COMPARATIVE 1 | 1 | COMPARATIVE 2 | 4 |
| Degradation | 0.16 | 0.44 | 0 | 0.40 |
| rate (ppm/min) | | | | |

It is noticed that the condensation level of the sol is an important parameter of the synthesis for non-pretreated materials. A sol having a lower condensation level will generate more bonds with the hydroxyl groups present at the surface of the TiO₂ and thereby reduce the number of active sites of the photocatalyst. On the other hand, with the pretreatment, microporosity will be generated which will give the possibility of opening up of TiO₂ and therefore becoming accessible for pollutants, thus suppressing the initial influence of the condensation level.

### EXAMPLE 5

### Influence of the Nature of the Organic Group of the Hybrid Silica Sol

Other silica sols including organic groups of the vinyl and propyl type were tested.

The hybrid sol having propyl groups is synthesized by acid hydrolysis of CH₃—CH₂—CH₂—Si(O—CH₂—CH₃)₃ precursors. Its synthesis procedure is identical with the one of the hybrid sol described in EXAMPLE 1. The sol used has a dry extract of 28% and a condensation level of 62%.

The hybrid sol having vinyl groups is synthesized by acid hydrolysis of CH₂═CH—Si(O—CH₃)₃ precursors according to the following procedure: 12 moles of acidified water with 10 g/l of citric acid are added to 1 mole of the previous precursor. The solution is heated to 35° C. for 17 hours. The alcohol is removed by distillation under reduced pressure in the rotary evaporator.

Two phases are formed, the aqueous phase located above is removed. Several washes with water are carried out for removing the trapped citric acid. The sol is put into solution in the ether. The solution is again washed with water. The aqueous phase located below is removed. MgSO₄ is added for suppressing the last water molecules. The ether is removed by distillation under reduced pressure. Ethanol, the final solvent is added and one proceeds with distillation under reduced pressure in order to remove the last trace amounts of ether and water. Ethanol is again added according to the desired dry extract. The sol used has a dry extract of 31% and a condensation level of 88%.

The remainder of the procedure for preparing the film remains the same as that of EXAMPLE 1. FIGS. 8A and 8B are scanning electron microscope images (SEM) of the surface of the coatings obtained in Examples 5-a and 5-b. These images show pores with random shape and size (with pore diameters between 20 and 500 nm for FIGS. 8A and 8B).

The evaluation of the photocatalytic activity of the material is carried out according to the method described in EXAMPLE 1. FIG. 9 shows the time-dependent change in the degradation of formic acid versus the UV irradiation time according to the nature of the organic group of the hybrid sol used. The photocatalytic activity was studied in each of the cases before (COMPARATIVE EXAMPLES 1, 3 and 4) and after the UVC pretreatment (EXAMPLES 1, 5-a and 5-b). Table 6 summarizes the obtained degradation rates.

TABLE 6

| | EXAMPLE | | | | | |
|---|---|---|---|---|---|---|
| | Compar- | | Compar- | | Compar- | |
| | ative 1 | 1 | ative 3 | 5-a | ative 4 | 5-b |
| Organic | methyl | methyl | vinyl | vinyl | propyl | propyl |
| group | | | | | | |
| Degrada- | 0.16 | 0.44 | 0.03 | 0.43 | 0.06 | 0.44 |
| tion rate | | | | | | |
| (ppm/min) | | | | | | |

It is noticed that the materials have a lower photocatalytic activity when they are not pretreated. Indeed, the propyl and vinyl groups will generate many intermediates during their degradation, unlike the methyl groups.

Good results are obtained when the materials are pretreated with UVC. Once all the organic groups are destroyed, the materials have a photocatalytic activity similar to 0.44 ppm/min of degraded FA.

### EXAMPLE 6

### Changing Photocatalysts

The TiO₂ nanoparticles are replaced with ZnO (Sigma-Aldrich, size<100 nm). The remainder of the procedure for preparing film is the same as the one of EXAMPLE 1.

FIGS. 10A and 10B are scanning electron microscope images (SEM) of the surface and of a section of the obtained material.

The film has a macroporosity with random shape and size ranging from 200 nm to about 1,400 nm. This macroporosity is greater than that of the film consisting of TiO₂ nanoparticles (between 50 and 300 nm). The thickness of the deposit is of about 200 nm.

### EXAMPLE 7

### Comparison of Example 1 with a Commercial Reference

The results obtained in EXAMPLE 1 are compared with a photocatalytic paper sold by Ahlstrom (ref. 1048) consisting of fibers coated with TiO₂ (PC500, Millennium, anatase 99%, size comprised between 5 and 10 nm) and of zeolites by means of an inorganic binder SiO₂.

The photocatalytic activity is evaluated according to the method described in EXAMPLE 1. FIG. 11 illustrates the degradation kinetics of formic acid versus the UV exposure time. Table 7 summarizes the obtained degradation rate.

TABLE 7

EXAMPLE No.

| | EXAMPLE 1 | EXAMPLE 7 |
|---|---|---|
| Degradation rate | 0.44 | 0.41 |
| (ppm/min) | | |

Although the film of Example 1 includes a protective silica matrix, it is ascertained that it leads to a photocatalytic activity comparable with that of the commercial product from Ahlstrom, a reference product in this field.

### EXAMPLE 8

### Application on Flexible Organic Supports

The synthesis procedure is identical with that of EXAMPLE 1. The solution is deposited on two different textile supports: A fabric consisting of non-woven fibers in polyethylene (PE) and a fabric consisting of woven fibers in polyethylene terephthalate, coated with a polyurethane (PU) varnish.

FIG. 12 shows the scanning electron microscope images (SEM) of the surface and of the section of the materials obtained in both cases (PE and PU).

The coatings deposited on the textile supports retain their porous structuration. The deposited thicknesses are greater, about 2 μm for PE and 6 μm for PU.

The thereby prepared coatings are treated by UVC irradiation (irradiation box, λ=254 nm) at a light intensity of 6 mW/cm² for 27 hours. During irradiation, the substrates are totally immersed in water.

The evaluation of the photocatalytic activity of the materials is carried out according to the method described in EXAMPLE 1. The activity of these flexible supports before and after UV treatment is compared with those of a coating deposited on an inorganic silicon substrate (Si, EXAMPLE 1). FIG. 13 illustrates the degradation kinetics of formic acid versus the UV exposure time. Like for Example 1, it is noticed that the photocatalytic activity of the flexible materials is greatly improved by applying the UV pre-treatment. The efficiency of the supports treated under UV radiation is quite comparable with that of a film deposited on an inorganic support. The photocatalytic solution is therefore transposable to the organic supports.

The evaluation of the flexibility of the films was carried out on a PU support with and without coating a photocatalytic film. The rigidity of the materials was evaluated by measuring the force required for folding a specimen by an angle of 30°. Table 8 summarizes the obtained results.

TABLE 8
Forces (mN) measured for folding a specimen by an angle
of 30°

| | Without any | Photocatalytic |
|---|---|---|
| PU Sample | varnish | varnish |
| Direction 1 | 138 | 134 |
| Direction 2 | 139 | 141 |

It appears that the deposition of the coating does not stiffen the organic support, even with a thickness of 6 μm. The measured forces are comparable with those of the non-coated support. The developed coatings therefore give the possibility of retaining the flexibility of the textiles.

1-41. (canceled)

42. A coating consisting of a polysiloxane, some silicon atoms of which are bound through a Si—C bond to at least one organic group, and wherein nanoparticles of a semiconducting material are distributed, wherein the coating is porous.

43. The coating according to claim 42, wherein the coating is macroporous.

44. The coating according to claim 42, wherein an illumination of the coating, when the latter is immersed in an aqueous solution, preferably in ultrapure water, does not cause any removal of the organic groups bound through a Si—C bond to the silicon atoms, present in the coating.

45. The coating according to claim 44, wherein the illumination not causing any removal of the organic groups bound through a Si—C bond to the silicon atoms, present in the coating, is achieved at 365 nm and at 312 nm with a respective light intensity of 10 mW/cm² and 3 mW/cm², for 6 hours at 22° C.

46. The coating according to claim 42, wherein 17 to 97% by moles, and preferably from 80 to 95% by moles of the silicon atoms present in the coating, are bound to a carbon atom.

47. The coating according to claim 42, wherein the organic groups bound to the silicon atoms through a Si—C bond are selected from alkyl groups notably having 1 to 6 carbon atoms, for example methyl, ethyl, n-propyl, iso-propyl, n-butyl, tert-butyl; aryl groups, for example phenyl; and the vinyl group.

48. The coating according to claim 42, comprising from 1 to 90% by mass, and preferably from 30 to 70% by mass of semiconducting material.

49. The coating according to claim 42, wherein the semiconducting material nanoparticles have a larger size belonging to the range from 5 to 100 nm.

50. The coating according to claim 42, wherein the semiconducting material nanoparticles are nanoparticles of TiO₂, ZnO, SnO₂, WO₃, Fe₂O₃, Bi₂O₃, SrTiO₃, CdS, SiC or CeO₂ or a mixture of such nanoparticles, the nanoparticles consisting of more than 50% by mass of TiO₂ anatase being preferred.

51. The coating according to claim 42, wherein the semiconducting material nanoparticles are nanoparticles of TiO₂, ZnO, SnO₂, WO₃, Fe₂O₃, Bi₂O₃, SrTiO₃, CdS, or a mixture of such nanoparticles, and the Si atoms/metal atoms ratio of the semiconducting material nanoparticles belongs to the range from 0.3/1 to 5/1, preferably 1.2/1.

52. The coating according to claim 42, wherein the coating is flexible.

53. The coating according to claim 42, wherein the coating has surface roughness.

54. The coating according to claim 42, wherein the coating comprises at least 90% by mass, and preferably exclusively consists of a polysiloxane matrix, for which at least one portion of the silicon atoms are bound through a Si—C bond to organic groups and of nanoparticles of a semiconducting material.

55. A textile material covered with a coating according to claim 42.

56. A support covered with a coating according to claim 42, the binding between the support and the coating being ensured via Si—O bonds.

57. The support according to claim 56 corresponding to a textile.
